(19) United States
(12) Patent Application Publication
(10) Pub. No.: US 2011/0141611 A1
(43) Pub. Date: Jun. 16, 2011

(54) METHOD AND APPARATUS FOR MEASURING DISK RUNOUT IN A DISK DRIVE

(75) Inventor: Daisuke SUDO, Ome-shi (JP)

(73) Assignee: KABUSHIKI KAISHA TOSHIBA, Tokyo (JP)

(21) Appl. No.: 12/868,635

(22) Filed: Aug. 25, 2010

(30) Foreign Application Priority Data
Dec. 16, 2009 (JP) 2009-285425

(51) Int. Cl. G11B 21/02

(52) U.S. Cl. 360/75; G9B/21.003

(57) ABSTRACT

According to one embodiment, a disk drive includes an actuator, a servo controller, and a calculation module. The actuator is configured to move the head over a disk, in the radial direction of the disk. The servo controller is configured to make the head move along a target orbit on the disk, in accordance with the distance the actuator has been moved. The calculation module is configured to calculate, as disk runout, a virtual target orbit value supplied to the servo controller to suppress the disturbance at the target orbit.

### CROSS-REFERENCE TO RELATED APPLICATIONS

This application is based upon and claims the benefit of priority from Japanese Patent Application No. 2009-285425, filed Dec. 16, 2009; the entire contents of which are incorporated herein by reference.

### FIELD

Embodiments described herein relate generally to a technique of measuring the disk runout of a disk incorporated in a disk drive.

### BACKGROUND

In most disk drives, a representative example of which is the hard disk drive, a magnetic head (hereinafter referred to simply as a head) records and reproduce data on the from a disk that is a magnetic recording medium. In the disk drive, the disk is secured to the shaft of a spindle motor and can be rotated by the spindle motor (SPM).

In the disk drive of such a structure, the disk may undergo a phenomenon called disk runout, because of, for example, the error in positioning the spindle motor. If the disk runout occurs, the servo track (servo cylinder) will deviate from the rotational orbit around the rotational center of the disk (i.e., rotational center of the SPM). (Thus, so-called servo track runout occurs.) The disk runout results in dynamic offset (DO), changing the read/write (R/W) offset as the disk rotates once.

In the disk drive, the head has a read head and a write head, which are spaced apart from each other. Since the read head and the write head are separated from each other, an offset (positional displacement) of a specific value exists between the track loci of the read head and write head in the radial direction of the disk. This offset shall hereinafter be referred to as R/W offset.

The disk drive has a servo control function of performing a write dynamic offset control (WDOC) for controlling the dynamic offset. The write dynamic offset control adjusts the R/W offset value at the time of writing data to the disk. In order to perform the WDOC appropriately, the value of disk runout (hereinafter referred to, when necessary, as a runout value or runout data) must be measured with high precision and the data representing this value must be stored in a memory or the disk. Methods of measuring the runout value have hitherto been proposed (see, for example, Jpn. Pat. Appln. KOKAI Publications Nos. 9-128915 and 9-330571).

In the method disclosed in the prior-art documents specified above, a servo signal is read and the runout is measured while the head remains physically stopped and stored in a memory in the form of a runout correction table. The controller uses the runout value in the table, correcting the position of the head. The head can thereby write data to a data track truly circular around the rotational center of the disk. The methods disclosed in the above-identified documents are designed to generate and store rotational locus servo data that controls the head, causing the same to move along its rotational locus, relative to the disk that keeps rotating. The controller controls the head in accordance with the rotational locus servo data.

The method disclosed in the above-identified documents corrects the runout, by using the runout data obtained by measuring the runout in an inner-periphery push scheme or a servo-free scheme. The head is thereby controlled to move along a truly circular locus, with respect to the disk.

In the inner-periphery push scheme, the actuator (i.e., carriage holding the head) is pushed to the stopper provided at the inner periphery of the disk. In this state, the head reads the servo data (position data), thereby measuring the disk runout. However, the method is disadvantageous in that fine dust particles (contaminants) are produced as the actuator is pushed onto the stopper every time the drive is activated. The dust particles may adversely influence the disk drive. In view of this, the method needs improvement to be utilized in practice.

In the servo-free scheme, the current of a specific value is supplied to the voice coil motor (VCM) of the actuator, by means of feed-forward control. At this point, the servo data (position data) is read, thereby calculating the runout value. This method, however, can hardly achieve stable measurement of the runout if disturbance occurs, because the head position deviates in the radial direction of the disk.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram illustrating the configuration of a disk drive according to an embodiment;

FIG. 2 is a block diagram of a servo control model according to the embodiment;

FIG. 3 is a diagram illustrating a disk runout, in connection with the embodiment;

FIG. 4 is a flowchart illustrating the sequence of DOC performed in the embodiment;

FIG. 5 is a flowchart illustrating a sequence of determining a disk shift in the embodiment;

FIG. 6 is a flowchart illustrating the sequence of measuring a disk runout in the embodiment;

FIG. 7 is a diagram showing the characteristic of the control value, which is observed in the embodiment and which accords with the disk runout measured; and

FIG. 8 is a diagram showing the characteristic of a target orbit, which is observed in the embodiment and which accords with the disk runout measured.

### DETAILED DESCRIPTION

Various embodiments will be described hereinafter with reference to the accompanying drawings.

In general, according to one embodiment, a disk drive includes an actuator, a servo controller, and a calculation module. The actuator is configured to move the head over a disk, in the radial direction of the disk. The servo controller is configured to make the head move along a target orbit on the disk, in accordance with the distance the actuator has been moved. The calculation module is configured to calculate, as disk runout, a virtual target orbit value supplied to the servo controller to suppress the disturbance at the target orbit.

(Configuration of the Disk Drive)

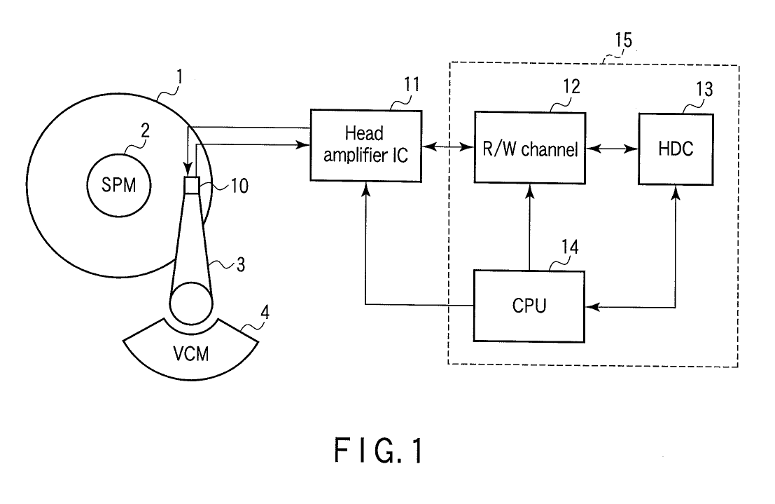

As shown in FIG. 1, a disk drive according to this embodiment a magnetic disk drive that has a disk 1 and a head 10. The disk 1 is a perpendicular magnetic recording medium. The disk 1 is secured to a spindle motor (SPM) 2, and can be rotated. The head 10 is mounted on an actuator 3 and can move over the disk 1 in the radial direction thereof. The actuator 3 is rotated by a voice coil motor (VCM) 4. The head 10 is so constructed that a write head and a read head are spaced apart from each other. The write head is configured to write data to the disk 10. The read head is configured to read data from the disk 10.

The disk drive further has a head amplifier integrated circuit (hereinafter referred to as a head amplifier IC) 11, a read/write channel (R/W channel) 12, a disk controller (HDC) 13, and a microprocessor (CPU) 14. The R/W channel 12, HDC 13 and CPU 14 are incorporated in a single-chip integrated circuit 15.

The head amplifier IC 11 receives a write signal (write current) from the R/W channel 12 and corresponding to write data, and supplies the write signal to the head 10. The head amplifier IC 11 further receives a read signal output from the head 10, and amplifies the read signal and sends the same to the R/W channel 12.

The R/W channel 12 is a signal processing circuit configured to encode the write data transferred from the disk controller 13, into write data, which is output to the head amplifier IC 11. The write data is to be recorded on the disk 1. The R/W channel 12 is also configured to decode the read data output from the magnetic head 10 into read data, which is output to the disk controller 13.

The disk controller 13 constitutes an interface between the disk drive and a host system (not shown) such as a personal computer, and controls the transfer of read data and write data. The CPU 14 is the main controller of the disk drive and performs servo control for controlling the read/write process and positioning of the head 10. The CPU 14 measures the disk runout and performs dynamic offset control (DOC). The DOC includes write dynamic offset control (WDOC).

(Disk Runout)

FIG. 3 is a diagram concerned with a disk runout measurement method according to this embodiment, and illustrating a phenomenon known as disk runout.

It should be noted first that a disk runout occurs when the disk 1 is secured to the SPM 2, because of the gap between the inner periphery of the disk 1 and the shaft of the SPM 2. Most desirably, the disk 1 must have a servo track 310 that is exactly concentric to the rotational center 200 of the SPM 2, as indicated by a solid line in FIG. 3. The servo track 310 is a track (cylinder) extending in the circumferential direction of the disk 1, with respect to the servo track holding the servo data. On the disk 1, many other servo tracks 310 are formed, which are spaced apart in the radial direction of the disk 1.

If a runout occurs, a point 300 deviating from the rotational center 200 becomes the center of the servo tracks. The distance between the rotational center 200 and the point 300 is the runout value.

In most disk drives, if the disk 1 undergoes disk runout, DO takes place, changing the R/W offset every time the disk 1 rotates. The CPU 14 therefore performs WDOC to adjust the R/W offset before data is written to the disk 1. To perform appropriate WDOC, the disk runout must be measured with high precision.

After the disk drive has been shipped as a product, the disk runout may result in a disk shift, particularly while the power switch of the disk drive remains off. To prevent the disk shift, it is necessary to measure the disk runout when the drive is activated, thereby to update the disk runout data that is used to determine whether a disk shift has taken place. Therefore, in most disk drives, the disk runout data (disk runout value) measured during the manufacture of the drive is stored in the flash memory or the disk incorporated in the disk drive.

(Servo Control)

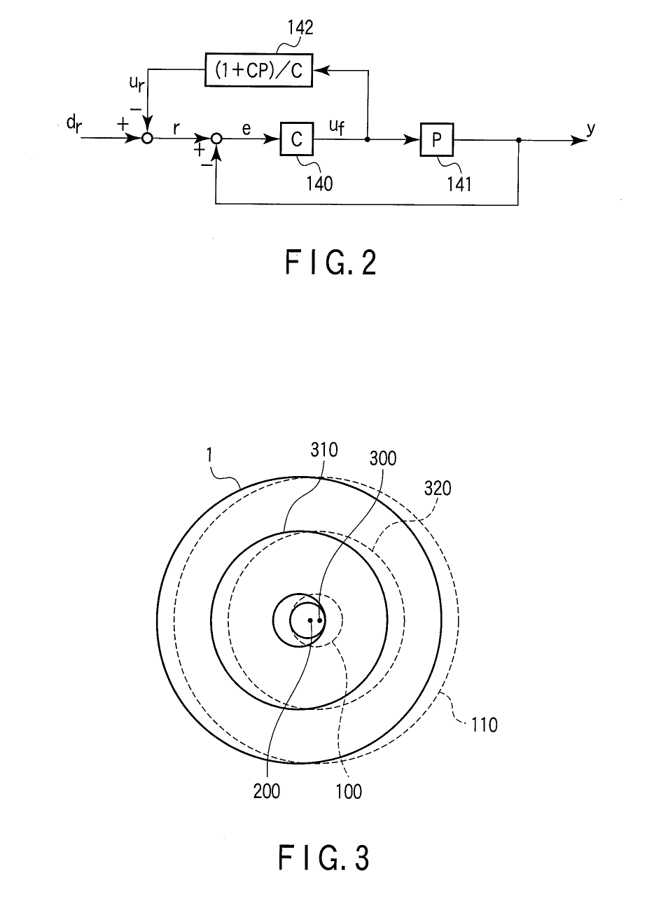

FIG. 2 is a block diagram of a servo control model the CPU 14 performs in the present embodiment.

The servo control model is composed of a feedback control model and a feedforward control model. The feedback control model is of ordinary type. The feedforward control model accords with this embodiment and is related to disk runout.

The feedback control model has a controller 140 and a plant 141. The controller 140 is a compensator (transfer function C) and is, in practice, the CPU 14. The controller 140 receives the data representing the positioning error e of the head 10 and calculates a control value Uf that will be used to eliminate the positioning error e. The plant 141 is a control object (transfer function P), and is the VCM 4. The plant 141 is driven and controlled in accordance with the control value Uf.

In the feedback control model, a control value y (here, the position data about the head 10), which is the output of the plant 141, is fed back to. The input to the feedback control model represents the target position (target orbit) r for the head 10. The positioning error e is, therefore, the difference between the target position r and the control value y fed back to the input of the controller 140.

The feedforward model of this embodiment has a controller 142 (for convenience, called a disk runout controller hereinafter in some cases). The disk runout controller 142 is configured to suppress the disturbance that accords with the disk runout. The disk runout controller 142 is a compensator that holds a transfer function ((1+CP)/C), and receives the control value Uf and outputs a virtual target-orbit value Url.

In this embodiment, the feedback control model is designed to apply a first-order sine wave as disturbance dr to the target position r as shown in FIG. 2, if a disk runout takes place. The disk runout controller 142 calculates, as disk runout value, the virtual target-orbit value Url obtained when the primary component of the control value Uf the controller 140 calculates becomes zero. Hence, it is necessary to determine the condition that changes the primary component of the control value Uf to zero. In the servo control model, the disturbance dr to the target orbit (target position) can be calculated, using the following equation:

$$dr = \frac{1 + CP}{C} Uf \qquad ( 1 )$$

The disk runout controller 142 can calculate the virtual target-orbit value Url, as a runout extracted by performing discrete Fourier transformation of the primary component of disturbance dr. Note that the plant 141 has characteristics deviating from the design values. It is therefore desired that a nominal model of the plant should perform feedback control, thereby converging the control value Uf to zero and calculating the disk runout value.

(Dynamic Offset Control)

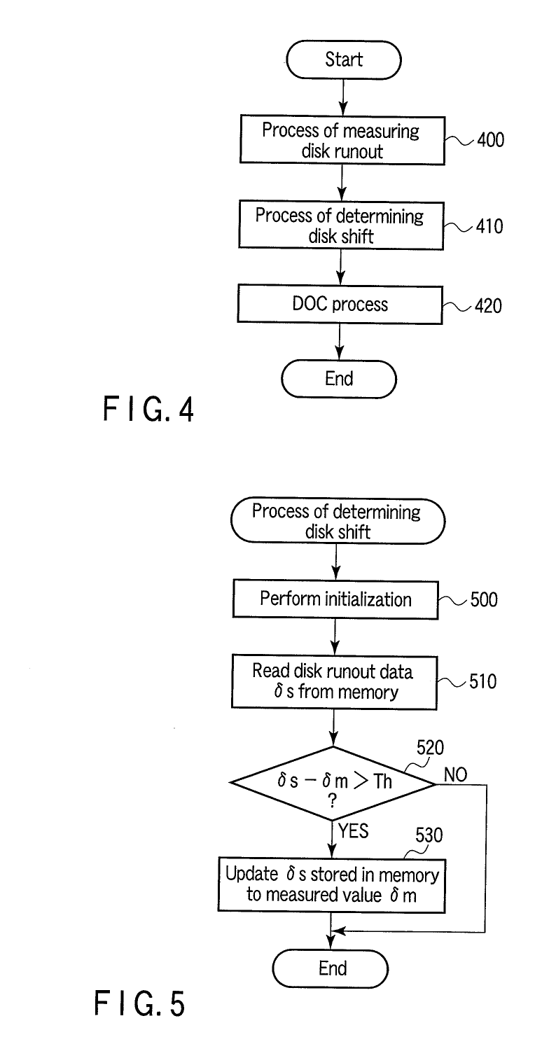

FIG. 4 is a flowchart illustrating the sequence of the dynamic offset control the CPU 14 performs.

After measuring the disk runout (Block 400) and determining the disk shift (Block 410), the CPU 14 performs dynamic offset control (DOC) (Block 420). Note that the disk runout is measured by a method according to this embodiment (called a virtual concentric servo-control method for convenience).

The disk shift is determined as will be explained with reference to the flowchart of FIG. 5. As shown in FIG. 5, whether the disk runout has resulted in a disk shift outside a tolerance range is determined. More precisely, the CPU 14 performs initialization, setting a threshold value Th used as reference value of decision (Block 500). The CPU 14 then reads the disk runout data δs from the disk or the flash memory (hereinafter, collectively refereed to as memory) (Block 510). The disk runout data δs represents the disk runout measured during the manufacture of the drive.

The CPU 14 determines whether the difference between the existing disk runout data δs and the disk runout data δm representing the disk runout measured (Block 520). If the difference exceeds the threshold value Th, the CPU 14 determines that the disk shift falls outside the tolerance range, and updates the disk runout data, updating the existing disk runout data δs to disk runout data δm in the memory) (Block 530). If the disk shift falls within the tolerance range, the disk runout data δs is maintained in the memory.

The CPU 14 uses the disk runout data (either δs or δm) stored in the memory, accomplishing the DOC process and positioning the head 10 at the target position (target track or target cylinder) provided on the disk 1, while performing the servo control on the head 10 that is writing or reading data to or from the disk 1. That is, for example, before the head 1 writes data to the disk 1, the CPU 14 performs WDOC to adjust the R/W offset value, positioning the head 10 at the target track in which the head 10 will record data.

(Process of Measuring the Disk Runout)

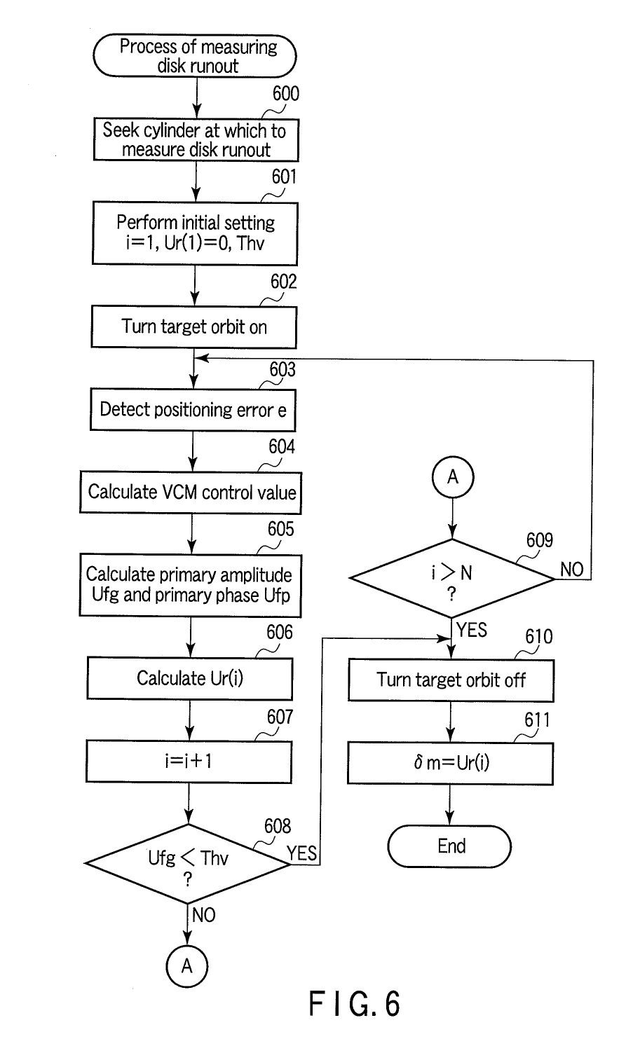

The process of measuring the disk runout by performing the virtual concentric servo-control method according to this embodiment will be explained with reference to the flowchart of FIG. 6.

First, the CPU 14 causes the head 10 to seek the track of which to measure the disk runout (Block 600). That is, the CPU 14 performs the feedback control in the servo control model of FIG. 2. Then, the CPU 14 initializes variables (i, Ur and threshold value Thy) (Block 601). That is, the CPU 14 performs feedback control in the servo control model shown in FIG. 2 (Block 602).

The CPU 14 then performs the feedback control, detecting the positioning error e (Block 603). The CPU 14 calculates a control value (VCM control value) Uf (Block 604). The control value Uf is output from the controller 140 to the plant 141 (VCM 4). The plant 141 is thereby driven and controlled. That is, the actuator 3 moves the head 10 to the track of which to measure the disk runout.

The CPU 14 receives the control value Uf from the feedback control model and inputs the same to the disk runout controller 142. On receiving the control value Uf, the disk runout controller 142 performs a DFT calculation process, calculating the primary amplitude Ufg and primary phase Ufp of the control value Uf (Block 605). Next, the CPU 14 causes the disk runout controller 142 to use the control value Uf, calculating a virtual target orbit value Ur(i) that does not accord with the disk runout, as indicated by the following equation (2) (Block 607). Note that the disk runout controller 142 calculates a virtual target orbit Url(i) not applied with gain G yet.

$$Ur ( i + 1 ) = \frac{1 + CP}{C} Uf + Ur ( i ) \qquad ( 2 )$$

At this point, the CPU 14 compares the primary component threshold value Thv of the control value with the primary amplitude Ufg (Blocks 607 and 608). If the control value has not converted to zero, the CPU 14 determines that the disk runout has not been correctly measured (NO in Block 608), and measures the disk runout again (Block 609). In this case, the last disk runout measured is set as virtual target orbit Ur to measure the measure the disk runout over again. The CPU 14 repeats the sequence of Blocks 603 to 609 until the primary component of the control value Uf becomes less than the threshold value Thy.

When the primary component of the control value Uf approaches zero, the CPU 14 turns off the disk runout controller 142, invalidating the virtual target orbit (block 610). When the virtual target orbit is thus invalidated, the control is switched from the feedback control to the servo control for the runout track. The CPU 14 stores the runout data thus obtained (i.e., virtual target orbit value Ur(i)), as variable δm, in the memory for some time (Block 611). Note that the CPU 14 stores the disk runout data δm in the memory (or in disk 1) if a disk shift outside the tolerance range is detected as shown in FIG. 5.

Therefore, as shown in FIG. 4, the virtual concentric servo control according to this embodiment can measure, with high precision, the disk runout, without impairing the operating reliability of the disk drive shipped from the manufacturer. Hence, if a disk shift outside the tolerance range is detected in the disk drive shipped, the CPU 14 may use the disk runout value measured (i.e., disk runout data δm stored in the memory), thereby performing dynamic offset control (particularly, WDOC).

The virtual concentric servo-control method according to this embodiment can measure the disk runout with high precision. That is, in this method, a virtual target orbit Ur is calculated, which causes the control value Uf used in the feedback control to become almost zero. Therefore, the disk runout value (i.e., disk runout data δm) can be obtained.

In the virtual concentric servo-control method according to this embodiment, the disk runout controller 142 performs the feedforward control if disturbance dr is generated. The disk runout can therefore be measured more accurately than in the conventional servo-free method. In the virtual concentric servo-control method according to this embodiment, the actuator 3 is, of course, not pushed onto the stopper. Therefore, fine dust particles would not be generated to cause contamination in the disk drive.

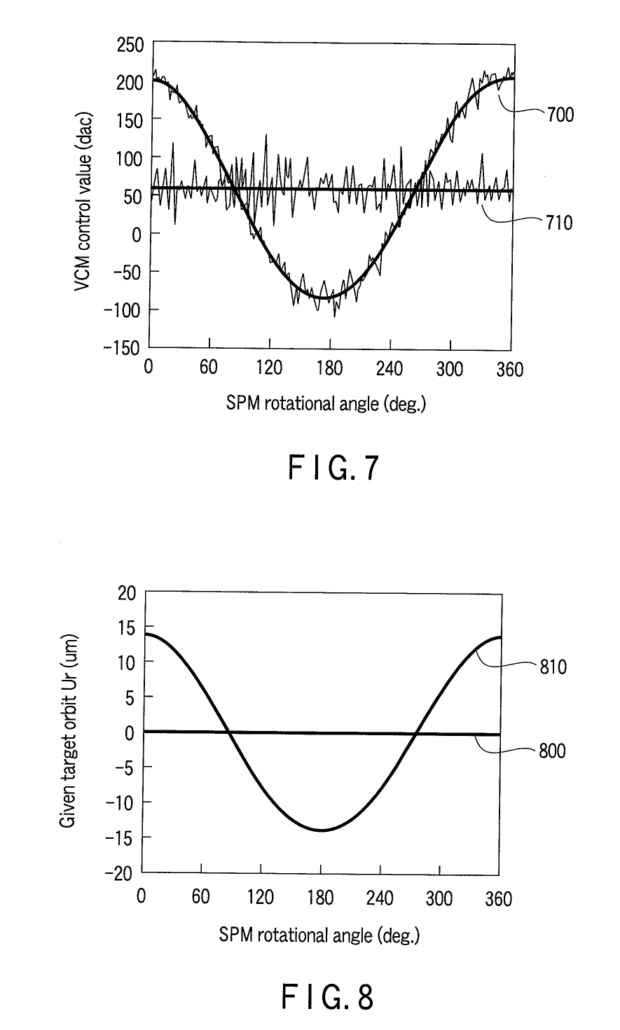

FIG. 7 is a diagram illustrating the characteristic of a control value that accords with the disk runout. In FIG. 7, dac is the current value an analog-to-digital converter outputs to the VCM 4. In FIG. 7, characteristic 710 pertains to the orbit correction achieved by using the virtual target orbit Ur in the present embodiment, whereas characteristic 700 pertains to the case where the head follows a track without performing the orbit correction.

FIG. 8 is a diagram illustrating the characteristic of the virtual target orbit Ur that accords with the disk runout measured in the present embodiment. In FIG. 7, characteristic 810 pertains to the orbit correction achieved by using the virtual target orbit Ur in the present embodiment, whereas characteristic 800 pertains to the case where the head follows a track without performing the orbit correction.

The various modules of the systems described herein can be implemented as software applications, hardware and/or software modules, or components on one or more computers, such as servers. While the various modules are illustrated separately, they may share some or all of the same underlying logic or code. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk drive comprising:
an actuator configured to move a head over a disk in a radial direction thereof;
a servo controller configured to control the head to follow a target orbit on the disk, in accordance with a control value for the actuator; and
a calculation module configured to calculate, as a disk runout value, a virtual target orbit value to be supplied to the servo controller in order to suppress a disturbance at the target orbit, in measuring a disk runout of the disk.

2. The disk drive of claim 1, wherein the calculation module is configured to receive the control value from the servo controller and to calculate the virtual target orbit value when the control value is substantially equal to zero.

3. The disk drive of claim 1, wherein
the servo controller comprises a feedback controller configured to calculate the control value for the actuator based on a positioning error of the head with respect to the target orbit; and
the calculation module comprises a feedforward controller configured to receive the control value and to suppress the disturbance applied to the feedback controller.

4. The disk drive of claim 1, wherein the calculation module is configured to calculate the virtual target orbit value for suppressing the disturbance when the head moves to a first position on the disk in order to measure the disk runout value.

5. The disk drive of claim 1, wherein the calculation module is configured to receive from the servo controller the control value in accordance with the disk runout and to calculate the virtual target orbit value for compensating the disk runout, on the basis of a preset transfer characteristic.

6. The disk drive of claim 5, wherein the servo controller is configured to receive the virtual target orbit value from the calculation module and to perform feedback control in order to converge the control value to zero.

7. The disk drive of claim 1, further comprising a detection module configured to detect a disk shift with the disk runout value calculated by the calculation module.

8. The disk drive of claim 7, further comprising a storage module configured to store disk runout data representing the disk runout value calculated by the calculation module, when the detection module detects the disk shift.

9. The disk drive of claim 8, further comprising a dynamic offset controller configured to eliminate a dynamic offset that changes when the disk rotates once, with the disk runout data stored in the storage module.

10. A servo control method for use in a disk drive configured to feedback control a head to follow a target orbit on a disk, in accordance with a control value for an actuator, the method comprising:
feedforward controlling for suppressing a disturbance at the target orbit in order to measure a disk runout value of the disk; and
calculating, as a disk runout value, a virtual target orbit value for suppressing the disturbance at the target orbit, from the control value input in order to feedforward control.
